(19) United States
(12) Patent Application Publication
(10) Pub. No.: US 2001/0021443 A1
(43) Pub. Date: Sep. 13, 2001

(54) Laminate against ballistic actions

(75) Inventors: Ingo Bornemann, Bursofeid (DE); Guido Schurmann, Krefeld (DE)

Correspondence Address: IP Department, Schnader Harrison Segal & Lewis, 36th Floor, 1600 Market Street, Philadelphia, PA, 19103, US

(73) Assignee: Verseidag-Indutex GmbH

(21) Appl. No.: 09/801,385

(22) Filed: Mar. 8, 2001

(30) Foreign Application Priority Data
Mar. 10, 2000 (DE) DE 100 11 701.5

(51) Int. Cl. B32B 3/00; B32B 27/14

(52) U.S. Cl. 428/196; 428/195

(57) ABSTRACT

The invention relates to a laminate as protection against ballistic actions, a plurality of layers composed of a fabric consisting of high-performance fibres being connected to one another only in places, so that a flexible laminate is obtained.

### FIELD OF THE INVENTION

The invention relates to a laminate which is used as protection against splinters or projectiles.

### BACKGROUND

It is known to use a laminate composed of layers of fabric consisting of high-strength fibre material as protection against ballistic actions, the individual layers being adhesively bonded to one another over their entire area by means of the matrix material with which the fibres of the fabric are coated. Laminates of this kind are relatively rigid and require a shaping device if they are to assume a predetermined shape.

Thus, an object of this invention is to improve protection against ballistic actions in laminates of this type.

### SUMMARY OF THE INVENTION

According to the invention, individual layers of which the laminate is composed are adhesively bonded to one another only partially, for example, in a punctiform manner.

The overall structure of the laminate thereby becomes flexible, because the individual layers are not connected to one another over their entire area, an improved protective effect against ballistic actions being obtained due to the flexibility of the laminate.

### BRIEF DESCRIPTION OF THE DRAWING

The invention is explained in more detail by way of example with reference to the drawing in which:

FIG. 1 reproduces diagrammatically a cross section through a laminate; and

FIG. 2 shows a top view of the laminate, with connection spots being illustrated.

### DETAILED DESCRIPTION

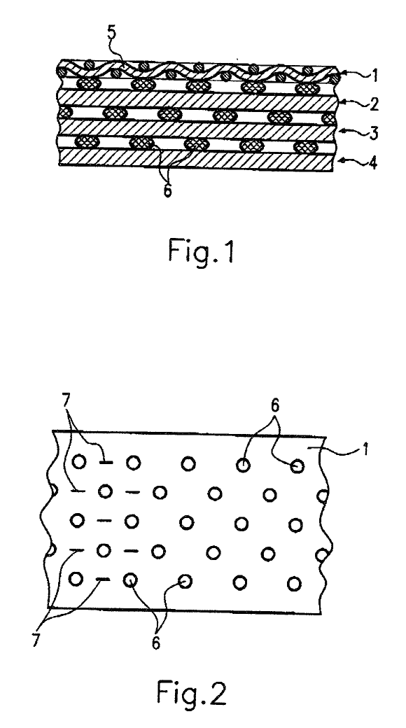

In practice, laminates with 10 to 50 layers of fabric are used and, for example, laminates with about 30 layers are used in bullet-proof vests. Merely by way of example, FIG. 1 shows diagrammatically a laminate consisting of four layers 1 to 4, each individual layer being formed from a fabric consisting of high-performance fibres 5. FIG. 1 reproduces, simply for the sake of clarity, a warp and weft thread at the layer 1 in order to illustrate a woven fabric. Various types of weave of the woven fabric may be provided.

Instead of a woven fabric, a knitted fabric, plaited fabric, stitched fabric or the like, consisting of high-performance fibres, may also be provided.

The individual layers 1 to 4 are connected to one another only partially be means of adhesive spots 6, as reproduced diagrammatically in FIGS. 1 and 2.

FIG. 2 reproduces diagrammatically adhesive spots 6 which may have only a small diameter of, for example, up to about 1 m and may be formed, for example, by adhesive being applied by means of a template. A punctiform adhesive bond between the individual layers is preferred. It is also possible, for example, to connect the outer layers 1 and 4 to the inner layers by means of smaller adhesive spots or fewer adhesive spots, whilst the inner layers 2 and 3 are connected to one another via larger adhesive spots or a larger number of adhesive spots.

In addition to the adhesive spots 6, the individual layers may also be sewn to one another in places, as indicated at 7 in FIG. 2, and connection by sewing may extend only between two adjacent layers or else over a plurality of layers.

The adhesive spots preferably have an arrangement which is offset to the arrangement of the adhesive spots of the next layer, as indicated diagrammatically in FIG. 1.

The adhesive provided may be a thermoplastic, but also an elastomeric and duromeric material, which is used as matrix material for laminates of this kind. A thermoplastic with high fusion viscosity is preferred, so that, during processing, the small-area or punctiform adhesive application also preserves its closely delimited shape and does not run too far apart. The adhesive or matrix component may be around 5 to 35% in relation to the fibre component of two layers connected to one another. The area covered by the adhesive may be around 10 to 95%, preferably between about 30 and about 75%.

When the laminate is being produced, first the individual fabric layers are formed by weaving, plaiting or the like, whereupon the adhesive material is applied to the fabric surface in an approximately punctiform manner by template application. The template may have, for example, a hole diameter of about 0.1 to about 2 mm, preferably about 0.5 to about 1.0 mm. After the fabrics have been coated with adhesive material at particular points, the individual layers are pressed together and thereafter cut to the necessary shaped pieces. Sealing of the high-performance fibres is expediently carried out on the outer faces of the laminate, in order, for example, to make these UV-resistant.

The individual layers may have a thickness dimension of about 0.2 to about 1 mm. A laminate composed of about 30 layers has a thickness dimension of the order of magnitude of 12 to 15 mm after pressing. In this case, even after pressing, the connection made only in spots between the individual layers is maintained.

The high-performance fibres used are preferably aramide fibres, high-performance polyethylene and PBO fibres. Glass fibres may also be used for construction the laminate.

What is claimed is:

1. A laminate as protection against ballistic action comprising a plurality of layers composed of a fabric containing high-performance fibres, the layers connected to one another only in selected places by adhesive spots, thereby forming a flexible laminate.

2. The laminate according to claim 1, wherein the adhesive spots between individual fabric layers is punctiform.

3. The laminate according to claim 2, wherein the adhesive spots having a diameter of about 0.1 to about 2 mm.

4. The laminate according to claim 1, wherein individual layers of the laminate are connected to one another by a different number of adhesive spots and/or a different size of adhesive spots.

5. The laminate according to claim 1, wherein adhesive spots in adjacent layers are arranged to be offset with respect to one another.

6. The laminate according to claim 1, wherein at least some individual layers are additionally connected to one another by sewing.

7. The laminate according to claim 1, wherein an area covered by the adhesive spots is between about 10 and about 95% of total area of respectively connected individual layers.

8. The laminate according to claim 1, wherein an area covered by the adhesive spots is between about 30 and about 75% of total area of respectively connected individual layers.
